(19) United States
(12) Patent Application Publication
(10) Pub. No.: US 2007/0091245 A1
(43) Pub. Date: Apr. 26, 2007

(54) Liquid crystal display device

(75) Inventors: Chih-Chieh Chang, Kuei shan Hsiang (TW); Pin-Chun Wu, Kuei Shan Hsiang (TW)

Correspondence Address: BACON & THOMAS, PLLC, 625 SLATERS LANE, FOURTH FLOOR, ALEXANDRIA, VA, 22314, US

(73) Assignee: Quanta Display Inc., Kuei Shan Hsiang (TW)

(21) Appl. No.: 11/442,327

(22) Filed: May 30, 2006

(30) Foreign Application Priority Data
Oct. 21, 2005 (TW) 094136856

(51) Int. Cl. G02F 1/1339

(52) U.S. Cl. 349/153

(57) ABSTRACT

A liquid crystal display device is disclosed, which comprises a upper substrate; a lower substrate; a liquid crystal layer; a sealing member sandwiched between the upper substrate and the lower substrate; and at least one rampart. The sealing member divides the space between the upper substrate and the lower substrate into a center region inside the sealing member and a peripheral region outside the sealing member. The rampart positioned in the center region divides the center region into a display region and a buffer region. The height of the rampart is smaller than the cell gap between the upper substrate and the lower substrate. Therefore, the level of the liquid crystal inside the display region can be properly controlled and the undesirable “gravity mura” phenomenon can be prevented.

### BACKGROUND OF THE INVENTION

1. Field of the Invention

The present invention relates to a liquid crystal display device and, more particularly, to a liquid crystal display device suitable for filling liquid crystal by one-drop fill-method (ODF).

2. Description of Related Art

Currently, the conventional method for filling the liquid crystal into the panel cells of a liquid crystal display device comprises following steps: (a) aligning and assembling the upper substrate and the lower substrate together to form a panel with an empty panel cell; (b) laying the panel into a vessel; (c) vacuuming the empty panel cell and immersing the panel into the vessel filled with liquid crystal; and (d) injecting the liquid crystal into the empty panel cell by the assistance of pressure difference and capillary effect.

But when the size of the panel of a liquid crystal display device becomes larger, as the evolution from the 5.5-th Generation glass substrate to the 7-th Generation substrate, the area of the display region of the panel to fill with liquid crystal increases. So the elapsed time for injecting the liquid crystal into the empty panel cell increases. Moreover, the amount of the liquid crystal wasted during the liquid-crystal-injecting process also increases. Hence the cost for manufacturing liquid crystal display devices increases.

The other method for filling the liquid crystal into the cells of the display region of the liquid crystal display device is the “one-drop-fill (ODF) method”. The method drops the liquid crystal on the surface of one of the substrates before aligning and combining the substrates together. The ODF method significantly reduces the elapsed time for the liquid crystal filling process and the amount of the liquid crystal wasted during the process.

As shown in FIG. 1, the spacer 60 sandwiched between the upper substrate 10 and the lower substrate 20 defines the cell gap 3 of the liquid crystal display device 1. Hence, the amount of the dropped liquid crystal is depends on the height of the spacer 60 in ODF process. After the liquid crystal is dropped, the upper substrate 10 and the lower substrate 20 are assembled together. While dropping the liquid crystal on the surface of the substrate, the amount of the liquid crystal must be carefully controlled. However, it is difficult to drop adequate amount of liquid crystal to match the critical amount for maintaining the height that the spacer is. If the amount of the liquid crystal drop is less than what is it required, a plurality of bubbles will be formed in the liquid crystal layer 2. In fact, the disadvantage of excessive injection of liquid crystal always happens in ODF process so far. These undesirable bubbles will deteriorate the performance of the liquid crystal display device, such as the brightness or the response time.

On the other hand, if the amount of the liquid crystal drop is much more than what it is required, the liquid crystal layer 2 maintains the cell gap of the substrates (see FIG. 2). In other words, the cell gap is not defined by the spacer 60, but it is defined by the liquid crystal layer 2 instead. As a result, the spacer cannot define the cell gap 3 inside the liquid crystal display device. Hence, a gap 95 generates between the spacer 60 and the lower substrate 20. Therefore, when the liquid crystal display device is placed vertically or near-vertically on the desk, the liquid crystal filled in the cells will flow downwardly and accumulate at the bottom of the panel of the liquid crystal display device. This is so-called “gravity mura” phenomenon. That is, the thickness of the panel of the liquid crystal display device is not consistent over the whole area of the liquid crystal display device. The display performance of the liquid crystal display device will deteriorate and the lifetime of the liquid crystal display device will be shortened as well.

Therefore, it is desirable to provide an improved liquid crystal display device which can control the level of the liquid crystal inside the display region of the liquid crystal display device and prevent the undesirable “gravity mura” phenomenon.

### SUMMARY OF THE INVENTION

The liquid crystal display device of the present invention includes a upper substrate; a lower substrate; a liquid crystal layer sandwiched between the upper substrate and the lower substrate; a sealing member sandwiched between the upper substrate and the lower substrate, wherein the sealing member divides the space between the upper substrate and the lower substrate into a center region inside the sealing member and a peripheral region outside the sealing member; and at least one rampart positioned in the center region, wherein the rampart further divides the center region into a display region and a buffer region, and the height of the rampart is smaller than the cell gap between the upper substrate and the lower substrate.

Another liquid crystal display device of the present invention includes a upper substrate; a lower substrate; a sealing member positioned in the space between the upper substrate and the lower substrate, wherein the sealing member divides the space into a center region and a peripheral region; and at least one rampart positioned in the center region, wherein the rampart further divides the center region into a display region and a buffer region; and a liquid crystal layer positioned in the center region, and the height of the rampart is smaller than the height of the sealing member.

Therefore, a space (buffer region) for receiving the overflowing liquid crystal is formed outside the display region. Besides, due to the height of the rampart is smaller than the cell gap between the upper substrate and the lower substrate of the liquid crystal device, there is a gap between the rampart and the upper substrate (or the lower substrate) or between two ramparts formed on the surface of the upper substrate and on the surface of the lower substrate respectively. The liquid crystal inside the display region can overflow into the space inside the buffer region through the gap. Therefore, the level of the liquid crystal inside the display region can be properly controlled, and the cell gap between the upper substrate and the lower substrate of the liquid crystal display device of the present invention can be maintained by the spacer thereinbetween, not the liquid crystal thereinbetween. Thus, the undesirable “gravity mura” phenomenon can be prevented. Moreover, since the space (buffer region) between the rampart and the sealing member is vacuumed and its pressure is much less than that of the space inside the active region, the overflowing liquid crystal flowing into the buffer region will not flow back into the active region again.

Furthermore, since the spacer of the liquid crystal display device of the present invention is formed on the sides of the upper substrate and the lower substrate, and the viscosity of the liquid crystal will be lowered if it's heated. When an additional “heat and spin” process is executed after the Vacuum Pressure Annealing (VPA) process, the overflowing liquid crystal will flow into the space between the rampart and the sealing member. As a result, the spacer can maintains the cell gap of the liquid crystal display device of the present invention. And the level of the liquid crystal inside the display region can be properly controlled. At the same time, the undesirable “gravity mura” phenomenon can also be prevented.

The rampart of the liquid crystal display device of the present invention can be formed on the surface of one of the upper substrate and the lower substrate of the liquid crystal display device of the present invention. That is, the rampart of the liquid crystal display device of the present invention can be formed on the surface of the upper substrate and on the surface of the lower substrate of the liquid crystal display device of the present invention. The arrangement of the ramparts is not limited, either. At this time, the ramparts is preferably formed on the surface of the upper substrate and on the surface of the lower substrate of the liquid crystal display device of the present invention alternatively; and the heights of the ramparts are smaller than the cell gap between the upper substrate and the lower substrate. Or, the ramparts is preferably formed on the surface of the upper substrate and on the surface of the lower substrate of the liquid crystal display device of the present invention correspondingly; and the sum of height of the rampart forming on the surface of the upper substrate and the height of the rampart forming on the surface of the lower substrate is smaller than the cell gap between the upper substrate and the lower substrate. Besides, the shape of the rampart of the liquid crystal display device of the present invention is not limited, either. The rampart preferably has plural notches to facilitate the flowing of the overflowing liquid crystal.

When the gap between the rampart and the upper substrate (or the lower substrate) or between two ramparts formed on the surface of the upper substrate and the lower substrate respectively is too large, a large amount of the liquid crystal will flow into the space (i.e. the buffer region) between the rampart and the sealing member during the ODF process. On the other hand, when the gap is too small, the overflowing liquid crystal inside the display region cannot flow into the buffer region efficiently during the ODF process and the following “heat and spin” process. Both of these situations will deteriorate the performance of the liquid crystal display device of the present invention.

Moreover, the upper substrate of the liquid crystal display device of the present invention can optionally further comprises at least one shielding layer. The ramparts can preferably be formed on the surface of the shielding layer of the upper substrate or on the surface of the non-display region of the lower substrate. The liquid crystal device of the present invention can optionally further comprises a plurality of spacers sandwiched between the upper substrate and the lower substrate and inside the display region of the liquid crystal display device of the present invention. Their heights are equal to the cell gap between the upper substrate and the lower substrate of the liquid crystal display device of the present invention. The arrangement of these spacers is not limited. The spacers can preferably be formed on the surface of the shielding layer of the upper substrate or on the surface of the non-display region of the lower substrate.

As a result, the level of the liquid crystal inside the display region of the liquid crystal display device of the present invention can be properly controlled and the undesirable “gravity mura” phenomenon can be prevented. Besides, the cell gap of the liquid crystal display device of the present invention is well maintained and the yield of the liquid crystal display device of the present invention is raised significantly.

Other objects, advantages, and novel features of the invention will become more apparent from the following detailed description when taken in conjunction with the accompanying drawings.

### BRIEF DESCRIPTION OF THE DRAWINGS

FIG. 1 is a cross section view of the conventional liquid crystal display device;

FIG. 2 is a cross section view of the conventional liquid crystal display device;

FIG. 3 is a cross section view of the liquid crystal display device of the first preferred embodiment of the present invention;

FIG. 4 is a cross section view of the liquid crystal display device of the second preferred embodiment of the present invention;

FIG. 5 is a cross section view of the liquid crystal display device of the third preferred embodiment of the present invention;

FIG. 6 is a top view of the liquid crystal display device of the present invention whose cross section views are shown in FIG. 3, FIG. 4 or FIG. 5;

FIG. 7 is a top view of the liquid crystal display device of the present invention whose cross section views are shown in FIG. 3, FIG. 4 or FIG. 5;

FIG. 8 is a cross section view of the liquid crystal display device of the fourth preferred embodiment of the present invention;

FIG. 9 is a top view of the liquid crystal display device of the present invention whose cross section view is shown in FIG. 8; and

FIG. 10 is a top view of the liquid crystal display device of the present invention whose cross section views are shown in FIG. 3, FIG. 4 or FIG. 5.

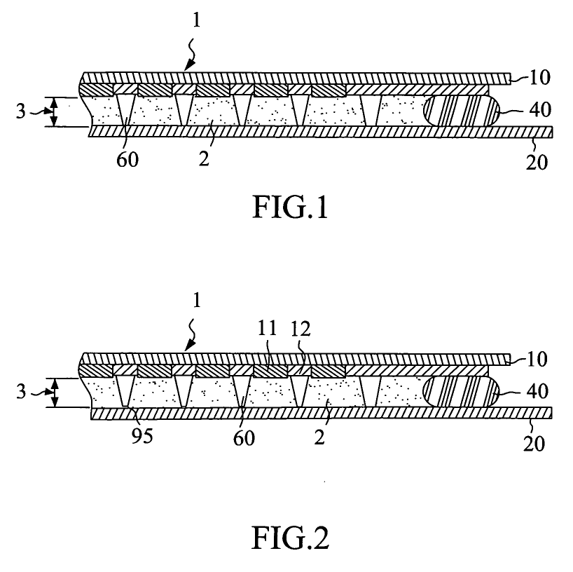

### DETAILED DESCRIPTION OF THE PREFERRED EMBODIMENT

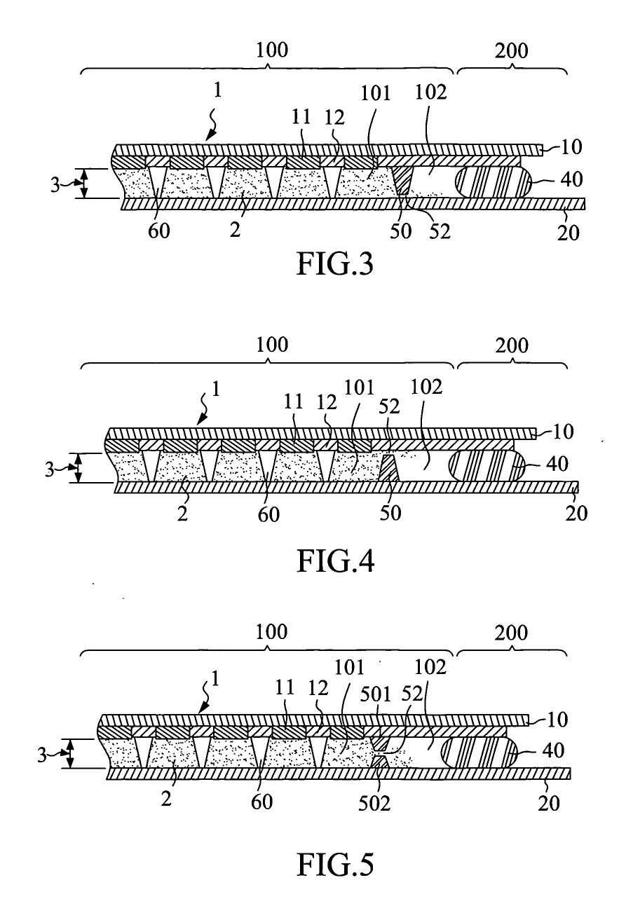

Please refer to FIG. 3, which is a cross section view of the liquid crystal display device of the first preferred embodiment of the present invention. The rampart 50 and the sealing member 40 are formed on the upper surface of the lower substrate 20. The sealing member 40 divides the space between the upper substrate 10 and the lower substrate 20 into a center region 100 and a peripheral region 200, while the rampart 50 divides the center region 100 into a display region 101 and a buffer region 102. The sealing member 40 seals the center region 100 and the liquid crystal is filled inside the display region 101. A plurality of pigment layers 11, a plurality of shielding layers 12, a plurality of spacers 60 and at least one rampart 50 are formed on a surface of the upper substrate 10. The pigment layers 11 are color filter sheets and the shielding layers 12 are black matrices, while the spacers 60 are formed inside the display region 101. Since the rampart 50 and the spacers 60 are formed on the surface of the shielding layer 12 of the liquid crystal display device 1, the performance of the liquid crystal display device of the present invention is not affected by the existence of the rampart 50 and the spacers 60.

In the present preferred embodiment of the present invention, the spacers 60 located between the upper substrate 10 and the lower substrate 20 defines the cell gap 3 of the liquid crystal display device 1 of the present invention. Since the rampart 50 is formed on surface of the upper substrate 10 only, the height of the rampart 50 is smaller than the cell gap 3 and the height of the spacers 60. Therefore, there is a gap 52 formed between the rampart 50 and the lower substrate 20.

When the ODF process is executed during the manufacturing process of the liquid crystal display device of the present invention, the liquid crystal (not shown) is dropped into the display region 101, which is inside the rampart 50 and corresponds to the pigment layers 11 of the upper substrate 10. At this time, there is no liquid crystal inside the buffer region 102. Later, after the VPA process is executed, the liquid crystal 2 is filled up the display region 101. The overflowing liquid crystal 2 then flows into the buffer region 102 automatically through the gap 52 between the rampart 50 and the lower substrate 20. Therefore, the level of the liquid crystal 2 inside the display region 101 can be properly controlled and as a result that the cell gap 3 is defined by the spacers 60 only.

Furthermore, since the gap 52 is so small and the buffer region 102 is vacuumed, the amount of the liquid crystal 2 flowed into the buffer region 102 is limited and the overflowing liquid crystal 2 cannot flow back into the display region 101. Therefore, the level of the liquid crystal 2 inside the display region of the liquid crystal display device of the present invention can be properly maintained and the undesired “gravity mura” phenomenon can be prevented.

Please refer to FIG. 4, which is a cross section view of the liquid crystal display device of the second preferred embodiment of the present invention. The difference between the liquid crystal display device of this preferred embodiment and that of the first preferred embodiment is that the rampart 50 is formed in the non-display region (not shown) of the lower substrate 20, not on the surface of the upper substrate 10. The height of the rampart 50 is smaller than the cell gap 3 and the height of the spacers 60 in order to form the gap 52 between the rampart 50 and the upper substrate 10.

After the VPA process is executed, the overflowing liquid crystal 2 flows into the buffer region 102 automatically through the gap 52. Therefore, the level of the liquid crystal 2 inside the display region 101 of the liquid crystal display device 1 of the present invention can be properly controlled and the cell gap 3 is defined by the spacers 60 only. Thus, the undesired “gravity mura” phenomenon can also be prevented.

Please refer to FIG. 5, which is a cross section view of the liquid crystal display device of the third preferred embodiment of the present invention. The difference between the liquid crystal display devices of this preferred embodiment and that of the first preferred embodiment is that the ramparts are formed both on the surface of the upper substrate 10 and the surface of the lower substrate 20. As shown in FIG. 5, the rampart 501 on the surface of the upper substrate 10 and the rampart 502 on the surface of the lower substrate 20 are formed correspondingly. The gap 52 is formed between the rampart 501 and rampart 502 and the sum of the height of the rampart 501 and the height of the rampart 502 is smaller than the cell gap 3 between the upper substrate 10 and the lower substrate 20 of the liquid crystal display device 1 of the present invention.

After the VPA process is executed, the overflowing liquid crystal 2 flows into the buffer region 102 automatically through the gap 52. Therefore, the level of the liquid crystal 2 inside the display region 101 of the liquid crystal display device 1 of the present invention can be properly controlled and the cell gap 3 is defined by the spacers 60 only. Thus, the undesired “gravity mura” phenomenon can also be prevented.

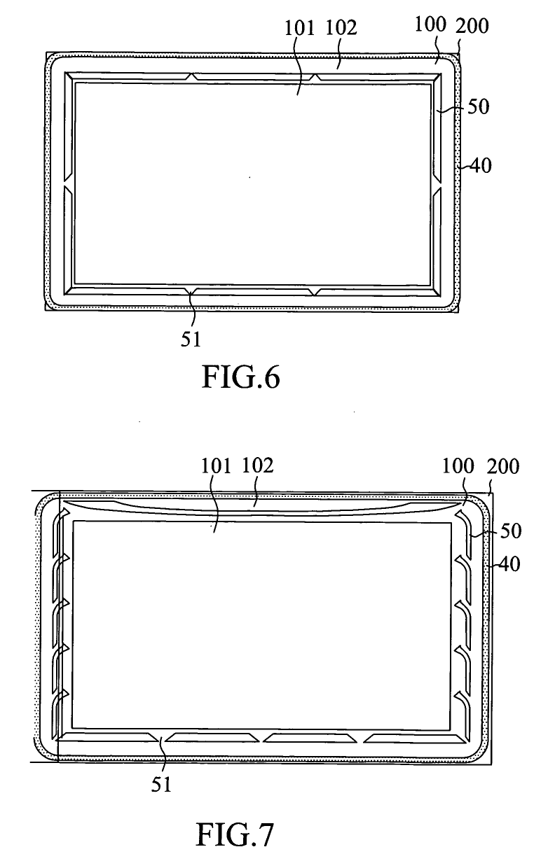

FIG. 6 is a top view of the liquid crystal display device of the present invention whose cross section views are shown in FIG. 3, FIG. 4 or FIG. 5. It shows that sealing member 40 seals the liquid crystal display device 1 of the present invention. Besides, the sealing member 40 also divides the space between the upper substrate (not shown) and the lower substrate (not shown) into the center region 100 and peripheral region 200. The rampart 50 divides the center region 100 into the display region 101 and the buffer region 102, wherein the display region 101 is filled with liquid crystal (not shown) and the buffer region 102 receives the overflowing liquid crystal (not shown) later.

In the liquid crystal display device of the present invention, the rampart 50 can optionally have plural notches. As shown in FIG. 6, the rampart 50 has notches 51 to allow the liquid crystal (not shown) to flow easily and laterally. Hence, with these notches 51 of the rampart 50, the overflowing liquid crystal (not shown) can flow downwardly, upwardly and laterally.

FIG. 7 is a top view of the liquid crystal display device of the present invention whose cross section views are shown in FIG. 3, FIG. 4 or FIG. 5, with different arrangement and shape of the ramparts. It shows that the sealing member 40 seals the liquid crystal display device 1 of the present invention. Besides, the sealing member 40 divides the space between the upper substrate (not shown) and the lower substrate (not shown) into the center region 100 and peripheral region 200. The rampart 50 divides the center region 100 into the display region 101 and the buffer region 102, wherein the display region 101 is filled with liquid crystal (not shown) and the buffer region 102 receives the overflowing liquid crystal (not shown) later. In this figure, only the rampart 50 at the lateral side of the liquid crystal display device has plural notches to allow the liquid crystal flow easily and laterally. Besides, the shape of these ramparts is specially designed to improve the efficiency of the flowing of the overflowing liquid crystal (not shown).

FIG. 10 is a top view of the liquid crystal display device of the present invention whose cross section views are shown in FIG. 3, FIG. 4 or FIG. 5, with different arrangement and shape of the ramparts. It shows that the sealing member 40 seals the liquid crystal display device 1 of the present invention. Besides, the sealing member 40 divides the space between the upper substrate (not shown) and the lower substrate (not shown) into the center region 100 and peripheral region 200. The rampart 50 divides the center region 100 into the display region 101 and the buffer region 102, wherein the display region 101 is filled with liquid crystal (not shown) and the buffer region 102 receives the overflowing liquid crystal (not shown) later. As shown in the figure, the obliquely arranged ramparts improve the efficiency of the flowing of the overflowing liquid crystal (not shown).

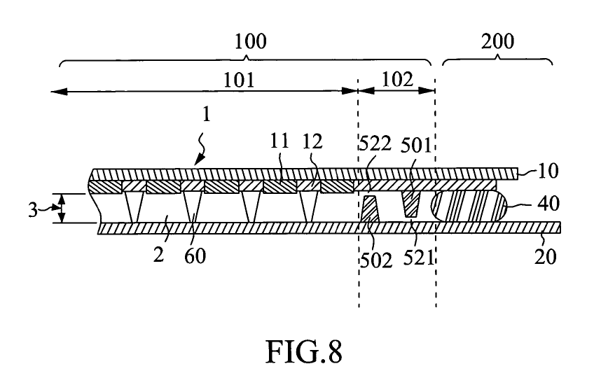

Please refer to FIG. 8, which is a cross section view of the liquid crystal display device of the fourth preferred embodiment of the present invention. The difference between the liquid crystal display devices of this preferred embodiment and that of the third preferred embodiment is that the ramparts are formed on the surface of the upper substrate 10 and the surface of the lower substrate 20 alternatively. As shown in FIG. 8, the rampart 501 is formed on the surface of the upper substrate 10 and the rampart 502 is formed on the surface of the lower substrate 20. The height of the rampart 501 and the height of the rampart 502 are both smaller than the cell gap 3 of the liquid crystal display device of the present invention. And the gap 521 is formed between the rampart 501 and the lower substrate 20, while the gap 522 is formed between the rampart 502 and the upper substrate 10.

After the VPA process is executed, the overflowing liquid crystal 2 flows into the buffer region 102 automatically through the gaps 521,522. Moreover, since the two gaps 521,522 are arranged in an “S” manner, the possibility of the liquid crystal's flowing back into the display region 101 is minimized.

As a result, the level of the liquid crystal 2 inside the display region 101 of the liquid crystal display device 1 of the present invention can be properly controlled and he cell gap 3 is defined by the spacers 60 only. Thus, the undesired “gravity mura” phenomenon can also be prevented.

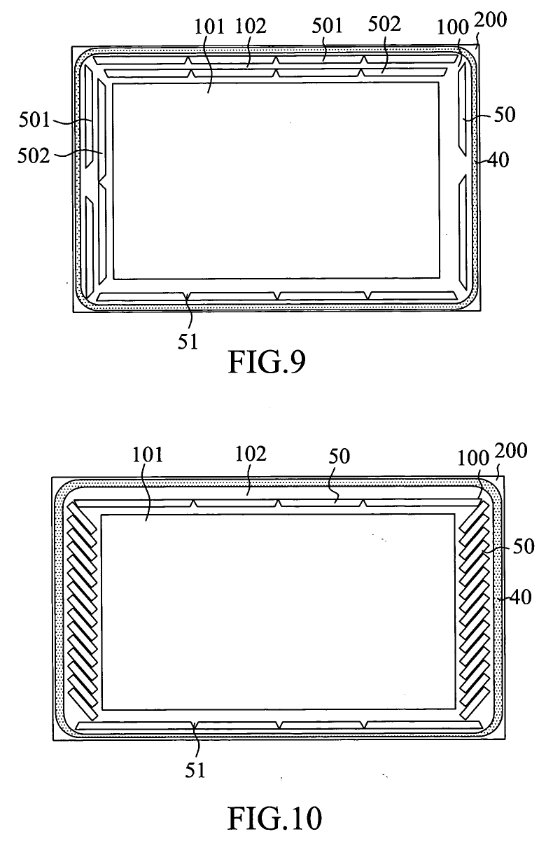

It should be noticed that because of specific operation requirements of the liquid crystal display device of the present invention, the arrangement of the ramparts positioned at different sides of the liquid crystal display device could be different from each other, such as the one shown in FIG. 9 which is a top view of the liquid crystal display device of the present invention whose cross section view is shown in FIG. 8.

In this figure, two rows of ramparts 501,502 are formed on the topside and the left side of the liquid crystal display device of the present invention, wherein the two rows of ramparts are formed on the surface of the upper substrate 10 and the surface of the lower substrate 20, respectively. Besides, these two rows of ramparts 501, 502 are formed alternatively, whose cross section view is as the one shown in FIG. 8. On the other hand, only one row of ramparts 50 is formed on the bottom side and the right side of the liquid crystal display device of the present invention, whose cross section view is as the one shown in FIG. 3, FIG. 4 or FIG. 5.

In summary, during the manufacturing process of the liquid crystal display device of the present invention, the ramparts are formed on the surface of the upper substrate and/or on the surface of the lower substrate by the lithography process. And once the cleaning process and the formation of the sealing members on the substrate is completed, the liquid crystal is dropped inside the display region and the two substrates are combined together in a vacuum environment (VPA process). Later, when the “heat and spin” process is executed, the liquid crystal flows into the buffer region between the rampart and the sealing member of the liquid crystal display device of the present invention rapidly and efficiently. As a result, the level of the liquid crystal inside the display region of the liquid crystal display device of the present invention can be properly controlled and the undesirable “gravity mura” phenomenon can be prevented.

Although the present invention has been explained in relation to its preferred embodiment, it is to be understood that many other possible modifications and variations can be made without departing from the scope of the invention as hereinafter claimed.

What is claimed is:

1. An liquid crystal display device, comprising:
an upper substrate;
a lower substrate;
a liquid crystal layer sealed and sandwiched between the upper substrate and the lower substrate;
a sealing member sandwiched between the upper substrate and the lower substrate, wherein the sealing member divides a space between the upper substrate and the lower substrate into a center region and a peripheral region, the center region locates inside the sealing member, and the peripheral region locates outside the sealing member; and
at least one rampart positioned in the center region, wherein the rampart further divides the center region into a display region and a buffer region, and the height of the rampart is smaller than the cell gap between the upper substrate and the lower substrate.

2. The liquid crystal display device as claimed in claim 1, wherein the rampart is located on a surface of the upper substrate or that of the lower substrate.

3. The liquid crystal display device as claimed in claim 1, wherein the rampart is located on a surface of the upper substrate and on a surface the lower substrate.

4. The liquid crystal display device as claimed in claim 3, wherein the rampart is located on the surface of the upper substrate and on the surface of the lower substrate alternatively, and the height of the rampart is smaller than the cell gap between the upper substrate and the lower substrate.

5. The liquid crystal display device as claimed in claim 3, wherein the rampart is formed on the surface of the upper substrate and on the surface of the lower substrate correspondingly, and the sum of the height of the rampart located on the surface of the upper substrate and the height of the rampart located on the surface of the lower substrate is smaller than the cell gap between the upper substrate and the lower substrate.

6. The liquid crystal display device as claimed in claim 1, wherein the rampart has plural notches.

7. The liquid crystal display device as claimed in claim 1, wherein the upper substrate comprises at least one shielding layer.

8. The liquid crystal display device as claimed in claim 7, wherein the rampart is located on the surface of the shielding layer of the upper substrate or on projection region of the shielding layer on the surface of the lower substrate.

9. The liquid crystal display device as claimed in claim 1, wherein the liquid crystal device further comprises a plurality of spacers locating between the upper substrate and the lower substrate, and the spacers are positioned in the display region and the heights of the spacers are larger than the height of the rampart.

10. The liquid crystal display device as claimed in claim 7, wherein the liquid crystal device further comprises a plurality of spacers locating between the upper substrate and the lower substrate, the spacers are positioned on the surface of the shielding layer of the upper substrate, and the heights of the spacers are larger than the height of the rampart.

11. An liquid crystal display device, comprising:
an upper substrate;
a lower substrate;
a sealing member positioned in a space between the upper substrate and the lower substrate, wherein the sealing member divides the space into a center region and a peripheral region;
at least one rampart positioned in the center region, wherein the rampart further divides the center region into a display region and a buffer region; and
a liquid crystal layer positioned in the center region;
wherein the height of the rampart is smaller than the height of the sealing member.

12. The liquid crystal display device as claimed in claim 11, wherein the rampart is formed on a surface of the upper substrate.

13. The liquid crystal display device as claimed in claim 11, wherein the rampart is formed on a surface of the lower substrate.

14. The liquid crystal display device as claimed in claim 11, wherein the rampart is located on a surface of the upper substrate and on a surface of the lower substrate.

15. The liquid crystal display device as claimed in claim 14, wherein the rampart is located on the surface of the upper substrate and on the surface of the lower substrate alternatively, and the height of the rampart is smaller than the cell gap between the upper substrate and the lower substrate.

16. The liquid crystal display device as claimed in claim 14, wherein the rampart is located on the surface of the upper substrate and on the surface of the lower substrate correspondingly, and the sum of the height of the rampart formed on the surface of the upper substrate and the height of the rampart located on the surface of the lower substrate is smaller than the cell gap between the upper substrate and the lower substrate.

17. The liquid crystal display device as claimed in claim 11, wherein the rampart has plural notches.

18. The liquid crystal display device as claimed in claim 11, wherein the liquid crystal device further comprises a plurality of spacers positioned in the display region and the heights of the spacers are larger than the height of the rampart.
